(19) United States
(12) Patent Application Publication
(10) Pub. No.: US 2015/0204130 A1
(43) Pub. Date: Jul. 23, 2015

(54) Door Closing Apparatus

(71) Applicant: Ford Global Technologies, LLC, Dearborn, MI (US)

(72) Inventors: Mark George Vojtisek, Royal Oak, MI (US); John W. Jaranson, Dearborn, MI (US)

(73) Assignee: Ford Global Technologies, LLC, Dearborn, MI (US)

(21) Appl. No.: 14/157,568

(22) Filed: Jan. 17, 2014

(51) Int. Cl. E05F 5/02; E05F 5/08; B60J 5/04

(52) U.S. Cl. CPC E05F 5/025; B60J 5/047; E05F 5/08

(57) ABSTRACT

An apparatus to facilitate vehicle door closing includes a rack gear engaging a pinion gear that are connected between the door and a hinge pillar. A spring is operatively connected to the pinion gear stores energy during a portion of a door opening motion and releases the stored energy to bias the door to close. A damper operatively connects the spring and the door to limit the door closing speed during a portion of the door closing motion. A power cinching mechanism may be operatively coupled to the door closing apparatus to assist in the final closing motion of the door.

### TECHNICAL FIELD

This disclosure relates to an apparatus for controlling the speed that a vehicle door closes to assure complete closure and reducing unwanted noise and harshness.

### BACKGROUND

Vehicles doors provide access to the passenger compartment. Vehicle doors are normally mounted to a hinge pillar of the vehicle using hinges and are pivotable about a vertical axis adjacent to the front of the door.

Existing vehicle door closing mechanisms are normally actuated by a vehicle user applying force to close the vehicle door. A broad range of forces can be applied which can result in a suboptimal closing. If excessive closing force is applied, the door may make an unrefined noise on closing. In addition, excessive force may result in damage to other door components leading to adverse NVH results. If insufficient closing force is applied, the door may not reach the fully closed position or may only partially latch.

The above problems and other problems are addressed by this disclosure as summarized below.

### SUMMARY

This disclosure is directed to an apparatus for controlling the speed that a vehicle door closes. The apparatus includes a rack gear engaging a pinion gear that are connected between the door and a hinge pillar. A spring operatively connected to the pinion gear stores energy during a portion of a door opening motion and releases the stored energy to bias the door to close. A damper operatively connects the spring and the door to limit the door closing speed during a portion of the door closing motion.

According to another aspect of this disclosure, an apparatus is disclosed for controlling pivoting movement of a door of a vehicle about a hinge pillar. The apparatus comprises a rack gear attached to the hinge pillar that extends into an opening defined in the door and a pinion gear operatively engaging the rack gear that rotates as the rack gear moves relative to the pinion gear. A spring is grounded to the door and operatively connected to the pinion gear to be wound in a first rotary direction when the door is opened to store energy, and is wound in a second rotary direction to release energy. A damper is operatively connected between the door and the spring to limit the closing speed of the door.

According to a further aspect of this disclosure, an apparatus is disclosed for controlling movement of a door for a vehicle. The apparatus comprises a rack gear extending between the vehicle door and a door pillar. The rack gear extends through an opening defined by the vehicle door. A pinion gear operatively engages the rack gear and rotates as the rack gear moves relative to the pinion gear. A pawl engages the pinion gear and a spring that is operatively connected to the pinion gear. The pinion gear winds the spring in a first rotary direction when the door is opened to store energy. The spring unwinds and turns the pinion gear in a second rotary direction when the door is closed. The pawl traverses a ramp and releases the energy stored by the spring as the door closes. A damper is operatively connected between the door and the spring to limit the speed that the door closes.

According to other optional aspects of this disclosure, the spring may be selected and arranged to release the stored energy at a predetermined torque level. A pawl may be operatively connected to the spring to release the stored energy biasing the door to close. The portion of a door opening motion during which energy is stored may be limited to a predetermined angular range. The apparatus may be operatively connected to a powered cinching mechanism that completes the door closing operation. The apparatus may communicate with a key fob that may be used to store data used to adjust the apparatus.

The above aspects of this disclosure and other aspects will be explained in greater detail below with reference to the attached drawings.

### BRIEF DESCRIPTION OF THE DRAWINGS

FIG. 1 is a fragmentary perspective view of a vehicle door that includes an apparatus for controlling the speed that the door closes.

FIG. 2 is an exploded perspective view of an apparatus for controlling the speed that a vehicle door closes.

FIG. 3A is a view of the door closing apparatus storing energy during door opening.

FIG. 3B is a view of the door closing apparatus during door closing.

FIG. 3C is a view of the door closing apparatus during door closing as the door closing apparatus is releasing previously stored energy to bias the door to close.

### DETAILED DESCRIPTION

The illustrated embodiments are disclosed with reference to the drawings. However, it is to be understood that the disclosed embodiments are intended to be merely examples that may be embodied in various and alternative forms. The figures are not necessarily to scale and some features may be exaggerated or minimized to show details of particular components. The specific structural and functional details disclosed are not to be interpreted as limiting, but as a representative basis for teaching one skilled in the art how to practice the disclosed concepts.

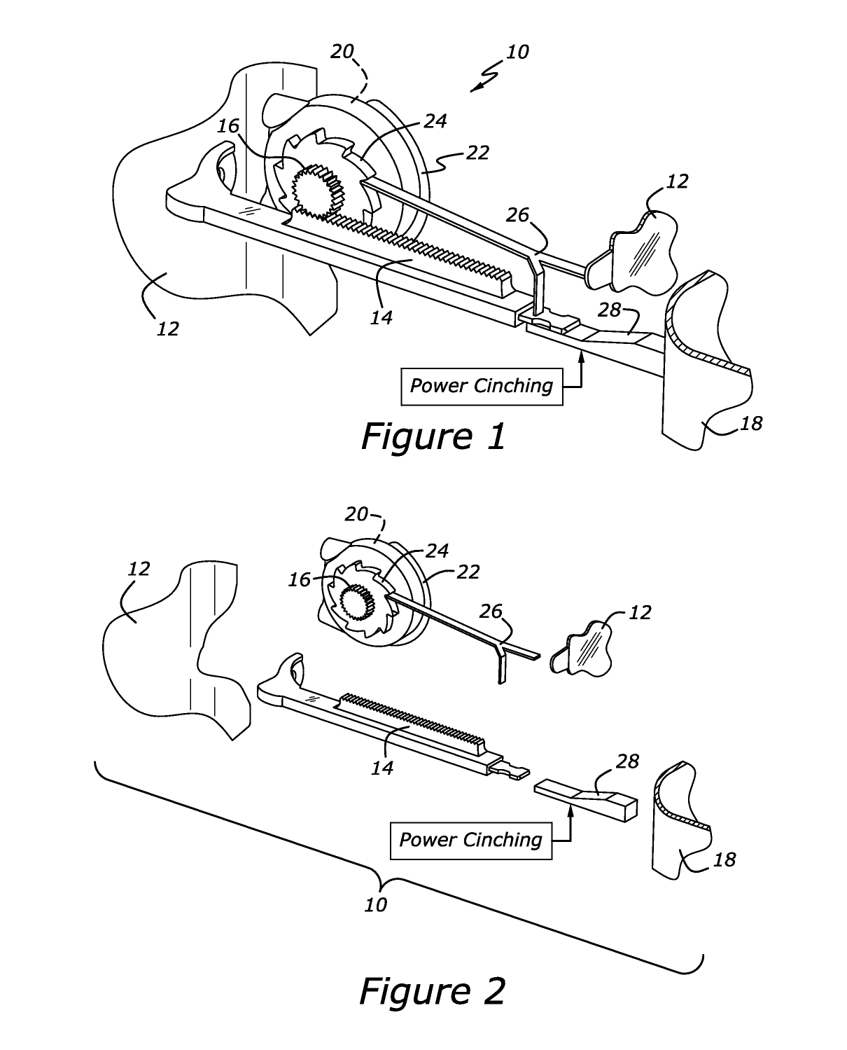

Referring to FIG. 1, reference numeral 10 designates a door closing apparatus for a door 12. As shown in FIG. 1, the door closing apparatus 10 may be provided to control the closing speed of the door 12. A rack gear 14 is disposed on the door 12 and a pinion gear 16 engages the rack gear 14. The pinion gear 16 and the rack gear 14 are disposed between the door 12 and a hinge pillar 18. A spring 20 is connected to the pinion gear 16. The spring 20 is wound in a first rotary direction when the door 12 is opened to store energy. The spring 20 is prevented from unwinding by a ratchet wheel 24. A pawl 26 is operatively engaged between the ratchet wheel 24 and a ramp 28 which is connected to the hinge pillar. Upon reaching a predetermined point in the closing motion, the pawl 26 disengages the pinion gear 16 to release stored energy in the spring 20 by unwinding the spring 20 in a second rotary direction to bias the door 12 to close. A damper 22 is operatively connected between the door 12 and the spring 20 to limit the closing speed of the door 12. The damper 22 is in operative engagement with the spring 20. The damper 22 and the spring 20 are engaged so that free rotation of the spring 20 is inhibited by the damper 22. A power cinching mechanism 30 may be operatively coupled to the door closing apparatus 10 to assist in the final closing motion of the door 12.

Referring to FIG. 2, a rack gear 14 is disposed on the door 12 and a pinion gear 16 engages the rack gear 14. The pinion gear 16 and the rack gear 14 are disposed between the door 12 and a hinge pillar 18. A spring 20 is connected to the pinion gear 16. The spring 20 is wound in a first rotary direction when the door 12 is opened to store energy. The spring 20 is prevented from unwinding by a ratchet wheel 24. A pawl 26 is operatively engaged between the ratchet wheel 24, the door 12, and a ramp 28. The ramp 28 is connected to the hinge pillar. The pawl 26 traverses the ramp 28 as the door closing motion proceeds. Upon reaching a predetermined point in the closing motion, the pawl 26 disengages the pinion gear 16 to release stored energy in the spring 20 by winding the spring 20 in a second rotary direction to bias the door 12 to close. The damper 22 is operatively connected between the door 12 and the spring 20 to limit the closing speed of the door 12. The damper 22 operatively engages the spring 20 to inhibit free rotation of the spring 20.

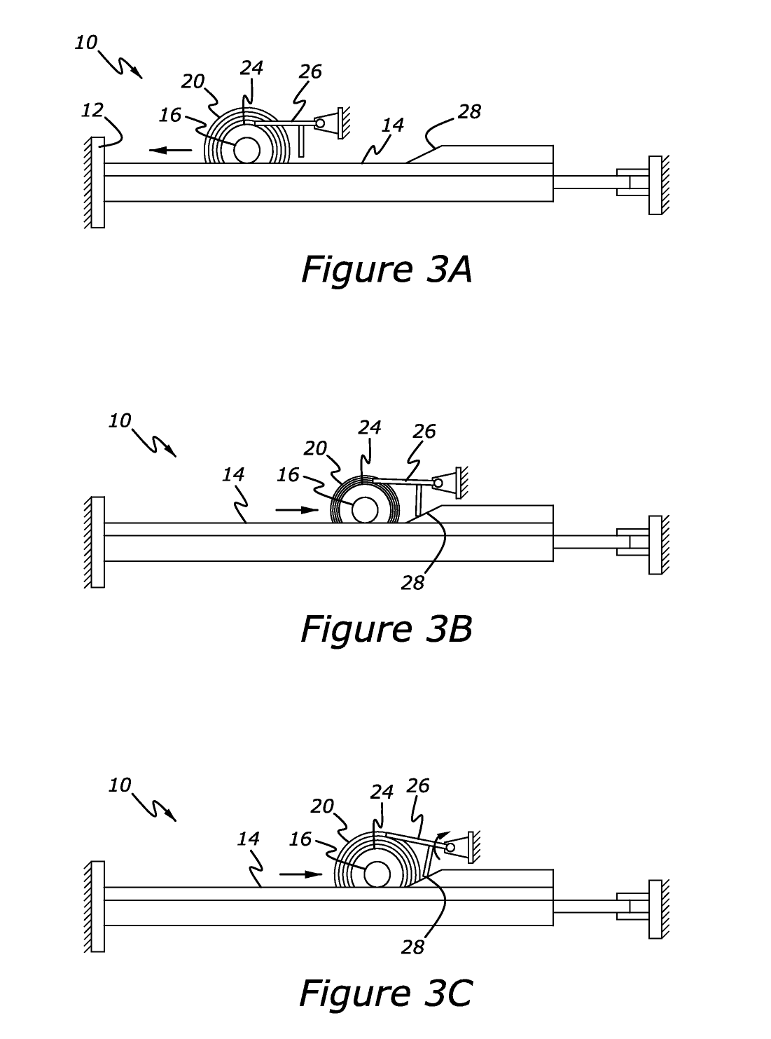

Referring to FIG. 3A, the door closing apparatus 10 is shown during door opening. The door closing apparatus 10 stores energy in the spring 20 when the door 12 is opened by winding the spring 20 in a first rotary direction, that is counter-clockwise as illustrated. The rack gear 14 is moved by the door opening motion. Engagement of the rack gear 14 by the pinion gear 16 during the door opening motion rotates the pinion gear 16 in the first rotary direction. The spring 20 is connected to the pinion gear 16 to store energy as the pinion gear 16 rotates in the first rotary direction.

Referring to FIG. 3B, the door closing apparatus 10 is shown during the door closing motion. The ratchet wheel 24 and pawl 26 prevent the spring 20 from releasing energy prior to a predetermined point in the door closing motion.

Referring to FIG. 3C, the door closing apparatus 10 is shown during door closing. The door closing apparatus 10 releases energy stored in the spring 20 by winding the spring 20 in a second rotary direction, that is clockwise as illustrated. The ratchet wheel 24 and pawl 26 prevent the spring 20 from releasing energy prior to a predetermined point in the door closing motion. When the predetermined point in the door closing motion is met as shown in FIG. 3C, the pawl 26 traverses the ramp 28 and disengages the ratchet wheel 24 allowing the spring 20 to release stored energy to bias the door 12 to close.

While exemplary embodiments are described above, it is not intended that these embodiments describe all possible forms of the disclosed apparatus and method. Rather, the words used in the specification are words of description rather than limitation, and it is understood that various changes may be made without departing from the spirit and scope of the disclosure as claimed. The features of various implementing embodiments may be combined to form further embodiments of the disclosed concepts.

1. A door closing apparatus, comprising:
a rack gear;
a pinion gear engaging the rack gear between the door and a hinge pillar;
a spring operatively connected to the pinion gear that stores energy during a portion of a door opening motion and releases energy to bias the door to close; and
a damper operatively connecting the spring and the door that limits speed of closing the door during a portion of the door closing motion.

2. The apparatus as claimed in claim 1, wherein the spring releases the stored energy at a predetermined torque level.

3. The apparatus as claimed in claim 1, wherein a pawl is operatively connected to the spring and the spring releases the stored energy to bias the door to close.

4. The apparatus of claim 1, wherein the portion of a door opening motion during which energy is stored is limited to a predetermined angular range.

5. The apparatus of claim 1, in which the apparatus is operatively connected to a powered cinching mechanism.

6. An apparatus for controlling pivoting movement of a door of a vehicle about a hinge pillar, the apparatus comprising:
a rack gear attached to the hinge pillar, the door defining an opening and the rack gear extending into the door through the opening;
a pinion gear operatively engaging the rack gear to rotate as the rack gear moves relative to the pinion gear;
a spring grounded to the door and operatively connected to the pinion gear, wherein the spring is wound in a first rotary direction when the door is opened to store energy, and wherein the spring is unwound in a second rotary direction to release energy; and
a damper operatively connected between the door and the spring that limits closing speed of the door.

7. The apparatus as claimed in claim 6, wherein the spring unwinds in the second rotary direction to release energy at a predetermined torque level.

8. The apparatus as claimed in claim 6, wherein a pawl is operatively connected to the spring in order to release stored energy by winding in a second rotary direction.

9. The apparatus of claim 6, wherein the pinion gear winds the spring in the first rotary direction within a predetermined angular range.

10. The apparatus of claim 6, further comprising a powered cinching mechanism that assists closing the door at the end of the door closing motion.

11. An apparatus for controlling movement of a door for a vehicle, comprising:
a rack gear extending between the vehicle door and a door pillar, the vehicle door defining an opening and the rack gear extending through the opening;
a pinion gear operatively engaging the rack gear to rotate as the rack gear moves relative to the pinion gear;
a ratchet wheel engaging the pinion gear;
a pawl engaging the ratchet wheel;
a spring operatively connected to the pinion gear, wherein the pinion gear is wound in a first rotary direction when the door is opened to store energy and is wound in a second rotary direction to release energy upon release of the spring by the pawl traversing a ramp which disengages the ratchet wheel in order to close the door; and
a damper operatively connected between the door and the spring that limits the speed that the door closes.
